(19) United States
(12) Patent Application Publication
(10) Pub. No.: US 2008/0044529 A1
(43) Pub. Date: Feb. 21, 2008

(54) Method of Preserving Ipomoea Aquatica, Method of Preserving Vegetables and Processed Food

(76) Inventor: Shigenobu Yamashita, Chiba (JP)

Correspondence Address: RABIN & Berdo, PC, 1101 14TH STREET, NW, SUITE 500, WASHINGTON, DC, 20005, US

(21) Appl. No.: 10/586,350

(22) PCT Filed: Jan. 14, 2005
(86) PCT No.: PCT/JP05/00347

§ 371 Date: May 8, 2007

(30) Foreign Application Priority Data
Jan. 15, 2004 (JP) 2004-038993
Jan. 21, 2004 (JP) 2004-043657
Jan. 27, 2004 (JP) 2004-050452
Sep. 30, 2004 (JP) 2004-314777

(51) Int. Cl. A23B 4/14; A01G 31/00; A23B 7/06; A23L 1/272; A23L 1/28

(52) U.S. Cl. 426/268; 426/419; 426/542; 426/615; 426/655; 47/59 R

(57) ABSTRACT

Effective utilization of vegetable called Ipomoea aquatica that although exhibiting high nutritional value and excellent antioxidant capability and ensuring huge supply capacity, is poor in distribution preservability and is notable in discoloration and quality degeneration attributed to processing, thereby disenabling merchandization of relevant processed food. There is provided a method of cultivating Ipomoea aquatica, characterized in that Ipomoea aquatica having been broadly classified as per flower color and leaf width is minutely classified as per whole leaf shape, leaf configuration appearing within a radius of equal to or less than 5.0 cm from leaf base and configurational difference among leaves from the same stem, and that an appropriate one is selected from among the resultant classes and cultivated. By virtue of this method, the distribution enduring period in fresh condition can be prolonged, and the discoloration by heating can be suppressed. Ipomoea aquatica can be resistant to discoloration by heating or freezing.

### FIELD OF THE INVENTION

The present invention is related to a preserving method and a processing method to provide new applications for farm products such as ipomoea aquatica which otherwise remarkably changes in color by being heated or frozen, and processed food of which quality deterioration such as the discoloration can be suppressed.

### BACKGROUND OF THE INVENTION

The ipomoea aquatica, called the chinese spinach or the morning glory, is a plant rich in minerals, having discriminating constituents, and having property subject to an eating habit with an excellent antioxidant ability, and further is an excellent foodstuff which has been supplied by a large amount and at low cost in warm temperate regions for a long time period, thanks to its excellent growing speed and regenerating ability.

However, use of the ipomoea aquatica has been limited despite its ability to have a large supply and its excellent nutritive value since the ipomoea aquatica spoils rapidly after a harvest and changes in color rapidly after being processed such as being heated or frozen. The use of the ipomoea aquatica stays in demand as a fresh vegetable in harvesting countries where the ipomoea aquatica is to be consumed in a limited period of time and to be cultivated as food for farm animals since a transportation means and preserving means after appropriate processes could not be found.

In order to resolve the problem stated above, a color change preventing method after being frozen or heated has been considered; however, a constant result has not been obtained even if the processing conditions and the cultivation conditions were adjusted, because the ipomoea aquatica was used as a specimen without knowledge of existences of segregateed variations according to the different genetic properties, which will be described later, the existences of mixed species and a mixed community of the ipomoea aquatica. That is, it has been considered that the ipomoea aquatica naturally changes in color after being heated or frozen with no exceptions, i.e., that there is no ipomoea aquatica which would not discolor after being processed by heating and freezing.

In view of the preceding, the ipomoea aquatica has been regarded as being a foodstuff which is difficult to process and thus studies are rarely made in its processing, distribution and components contained therein as food, and use of the ipomoea aquatica in view of the functions thereof. In other words, studies of the ipomoea aquatica focus on its water decontamination property and metal absorption property from soil, but almost no study has been made as to the discoloration due to the heating process and the like regardless of the effectiveness of the ipomoea aquatica for use as food.

The reasons why the studies of the ipomoea aquatica have not been made were: it was not possible to recognize that there were genetic differences of the types of the ipomoea aquatica, since there was no knowledge that the mixed community was actually constituted by the mixed species of which leaf shapes were different partially in a plurality of segregateed kinds and even in the segregateed same kinds; and while no attention has been paid to those genetic differences, a test of the discoloration after being heated or frozen has been repeated and thus the constant result could not be obtained, resulting in giving up further studies of the ipomoea aquatica, namely, the “ipomoea aquatica” was regarded as a vegetable always showing the discoloration after heating process and freezing process, under such circumstances that the ipomoea aquatica was only loosely classified into types of cultivated in soil and water and into types of bamboo leaves (or bamboo-leaved, or green stem) and wide leaves (or large-leaved, white stem).

While the ipomoea aquatica is classified commonly in every country into two types by width of leaf and into two types by a cultivating method such as the water cultivation and the soil cultivation, no further classification has been made since epithet names and distributing region vary. Further, the ipomoea aquatica establishes mixed communities due to a strong growing ability and thus there are various mixed species in the case that only the leaf shapes are compared to each other. Still further, there are lots of unknown points in genetic differences and the classifications and types of the ipomoea aquatica, which have already been segregateed and are now under study. Furthermore, with regard to those already segregateed ipomoea aquatica, studies thereof are not made as to the differences of the changes in color type by type since there is a ready-made idea that the ipomoea aquatica changes in color after being heated or frozen.

When producing a frozen vegetable and a water boiled vegetable, the vegetables are facilitated in oxidization by a material washing process using hypochlorous acid, due to a contact with metal ion or oxygen caused by peeling of epidermis or cutting of the material, and due to a contact with metal ion or pro-oxidant contained in processing water such as a blanching water, a cooling water, a glazing water used at a time of freezing the material.

To the contrary, in the conventional art, the final product is distributed in the market if a color of the final product is acceptable by the market thanks to a technique in which suppression of the oxidization is a main purpose, the suppression of the oxidization being done by a deactivation of an enzyme by a blanching and a block of the air by glazing.

With the technique described above, the readily oxidized substances such as polyphenol and vitamin are oxidized immediately and thus the essential antioxidation ability lowers. However, this problem has been controlled since a large change in appearance such as the discoloration was not seen.

The enzyme is deactivated by the blanching, and therefore the oxidization of the polyphenol due to the enzyme stops. However, the polyphenol remains after the blanching since it is strong against the heat and thus the polyphenol reacts with the metal ion or the like to advance the oxidization after the freezing process.

Since the polyphenol contacts the blanching water while blanching and processed water such as glazing water and filling water during the preservation of the materials over a long time period, reactions with acid, oxygen and metals contained in the processed water advance.

Accordingly, the changes in color occur due to the oxidization of the polyphenol and the reaction with the metals and thus those are considered as being unsuitable as the processing material such that it was not commercialized, but rather abandoned.

The ipomoea aquatica has unfavorable characteristics such as the rapid discoloration after the heating process or the freezing process, a partial change into black color, and an occurrence of wrinkles especially on stems since the stems are hollow after the defrosting of the ipomoea aquatica, creating a bad appearance. Further, in a case of the fresh ipomoea aquatica, the freshness lowers rapidly to show black spots on damaged portions or to turn into yellow color, resulting in degradation of the product. Therefore, the ipomoea aquatica is only suitable for a short distribution period or a short preserving period. That is, the ipomoea aquatica is consumable within a limited period of time and for the limited use while it is fresh as described above.

The present invention provides four advantageous results such as a development of a distribution lasting time elongating method for the ipomoea aquatica which has been considered as being unsuitable for the distribution and being processed; a collection of the ipomoea aquatica which hardly changes in color simultaneous with an identification of portions and kinds of ipomoea aquatica which hardly change in color and the cultivation method of the ipomoea aquatica having such characteristic; a processing method for suppressing the discoloration and deterioration of the quality of the ipomoea aquatica; and a development of use of the ipomoea aquatica having an additional value, the additional value of the ipomoea aquatica not being adversely affected by the discoloration in order for an effective use of the ipomoea aquatica. Specifically material points of the present invention are, upon running a test of the discoloration of the ipomoea aquatica after being heated, to conveniently segregate the kinds of the ipomoea aquatica according to the characteristic shapes of the leaves among the kinds of the ipomoea aquatica which have been segregated but are still under study, and to observe comparison results of the effects produced in the test run under the common conditions using the leaves having the same shapes. In other words, in order to avoid an affect from the cultivation soil, the cultivation temperature and the freshness, the ipomoea aquatica harvested at the same region and at the same time should be obtained to sort them according to the shapes of leaves for the use of the specimen. With the method stated above, a certain attempt becomes more clear which could not be found in the conventional method.

According to a first aspect of the present invention, a distributing method and a preserving method of the fresh vegetable is provided. More specifically, apart from the types of the ipomoea aquatica which are apt to deteriorate, the present invention achieves suppression of the quality deterioration by a method suitable for all the types of the ipomoea aquatica, to expand a distributable region by elongating an acceptable period of time for the ipomoea aquatica to be distributed and preserved, and to enable use of the ipomoea aquatica in the region and the season in which the fresh ipomoea aquatica was not conventionally available.

According to a second aspect of the present invention, such a process is performed that portions and types of the ipomoea aquatica suitable for being processed are selected, the ipomoea aquatica of a type hardly changing in color is selected to be cultivated, and the selected ipomoea aquatica hardly changing in color is collected, and thus a processed food suitable for the distribution such as frozen processed food and water boiling processed food are provided by using the above stated material. Further, the present invention provides the fresh product having the additional value of hardly being discolored even after cooking.

According to a third aspect of the present invention, a new prerequisite that the same shapes of leaves will have the same genetic characteristics is added to the test of the processing method in which the attempt is made in order to suppress the discoloration after being heated as stated above, thereby observing a trend and an effect of the classified matters. Considering the above, products such as frozen processed product, water boiled product and the like of which commercial value would not be lowered is provided by developing a method for suppressing the discoloration and change in quality caused by the heating process and the freezing process which commonly occurs for other ipomoea aquatica.

According to a fourth aspect of the present invention, the ipomoea aquatica is subjected to an effective utilization by developing new use thereof as a food additive, a processing material in which the commercial value is unaffected by the discoloration, a functional food or a specific substance extracting material, taking into account that the ipomoea aquatica has an excellent antioxidation power, can be supplied in large quantity, and is a material of high safety in cultivation and distribution management for eating habit.

The present invention was made aiming at a purpose of achieving common use of nutrition such as rich mineral value and common use of functions such as an excellent antioxidation power that ipomoea aquatica originally has, although the ipomoea aquatica used to be used in limited regions, limited seasons and limited uses while having the ability to be distributed by in large quantities and having a vast supplying capacity.

Further, in the conventional frozen vegetable and the boiled vegetable, appearances thereof such as the colors and prices thereof are the most important matter, and thus the antioxidation power which is a material property of a vegetable has been considered less serious in product value. Therefore, some of the vegetables are considered as having low or no product value for the reason that some of the vegetables, including a great deal of polyphenol, discolor disregarding an essential nutrition value the vegetables have.

The polyphenol that is not destroyed by the heating process will gradually be oxidized not only during the manufacturing process and the preserving period, but also after the blanching or a cooking process, and therefore, the discoloration occurs depending on the type and amount of the polyphenol contained in the vegetable or the type and amount of metal contained in the vegetable, and further depending on combinations thereof, results in being considered as a vegetable having low or no product value.

Conventionally, attention is only paid to chlorophyll, pigment, metal ion and the like and therefore, attention is only paid to pH control. As such, no resolution has been found for the problem caused by the discoloration due to the polyphenol which is prone to be oxidized, and the attempt to produce the boiled vegetable and the frozen vegetable with the ipomoea aquatica have not been done, so that the ipomoea aquatica has not been effectively used.

The reason why these problems were left as they were is because there is a complex problem which can not be resolved by a simple pH control or a mere addition of specific additives due to a mixture of various kinds of polyphenol such as anthothcyanin and chlorogenic acid which are involved in the discoloration and a mixture of antioxidation substances other than the polyphenol.

The problem becomes more complex due to the destruction of cells caused by the blanching, heating, and more often by the freezing or due to a change in property of the contained components or further due to contact between the components inside the cell and the components outside the cell, such contact not normally occurring in a living body.

The present invention is directed to achieve commercialization of the firm commodities which have a strong antioxidation, i.e., which are an excellent food, but which were not commercialized due to the discoloration or due to a low commercial value which involved limited use, and further, the present invention is directed to achieve wide and convenient use. Therefore, the present invention was proposed, while considering the discoloration, focusing on how to prevent the lowering of the antioxidation of the firm product which naturally has and can provide a large contribution to the human health when providing such a firm product preserved by freezing or under room temperature.

The first problem to be resolved by the present invention is the development of the new distribution method of the ipomoea aquatica as the fresh vegetable. The suitable distribution method of the ipomoea aquatica according to the present invention includes the essential light shielding, sealing, water supply and maceration up to leaves while transportation and preservation of the ipomoea aquatica, in order to elongate the preservation lasting period of time, in addition to preservation at low temperatures at around 0° C. that was hardly utilized as the preservation method for the dark-green vegetables which are produced in order to eat leaves and stems and grown in warm-temperature regions.

The second problem to be resolved by the present invention is the specification of portions and types suitable for being processed and being subjected to the growing method. A kind of the ipomoea aquatica with the least degree of discoloration is so specified that the ipomoea aquatica which are harvested in the same growing region at the same season are collected in order to exclude the affect by the growing conditions, the ipomoea aquatica which are considered as being derived from the same roots but being a mixture having the different shapes of leaves are excluded, the ipomoea aquatica are segregated into types in accordance with the shapes of leaves for the sake of convenience, thus segregated ipomoea aquatica are subjected to the blanching, cooling, freezing, defrosting, refreezing or redefrosting process in order to observe the discoloration of each type in each process, the experiments are performed with a large number of the ipomoea aquatica harvested in the different growing regions and of the different types, resulting in the ipomoea aquatica having portions of lesser degrees of discoloration and the ipomoea aquatica with less discoloration are ranked in view of the shapes of the leaves.

Further, since the ipomoea aquatica can be regenerated from a cut portion if the roots remain after being cut and harvested and can grow in a remarkably short period of time, a method for selectively growing the kind of ipomoea aquatica that has less discoloration is invented by repeating such processes that the roots are specified to harvest the portions above the stem portions, the cut portions are heated or frozen in order to observe the discoloration, and the roots which hardly discolor are separated to be grown selectively, and therefore, repetition of this process enables exclusion of the kinds showing the remarkable discoloration and exclusion of the mixed species.

Still further, the kinds of ipomoea aquatica that hardly discolor are already specified according to the present invention, so that such method is invented that those kinds of ipomoea aquatica are to be selected and the mixed species which does not show differences in appearance, for example, in the leaves, but which show the different degree of discoloration after being heated are observed by the method stated above regarding the conditions of the mixed community of those mixed species in order to exclude those mixed species.

The third problem to be resolved by the present invention is a method for suppressing the discoloration and change in quality after being processed. In such a method, with a new premise of a conventional concordance of the genetic characteristic according to the shapes of leaves being added to the test of the processing method for suppressing the discoloration after being heated as stated above, additives for suppressing the discoloration and change in quality which occurs commonly between the various ipomoea aquatica due to the heating process and the freezing process and adding processes are so specified that neutral processed water with low hardness is used, the blanching is performed under constant conditions in order to prevent the discoloration according to an enzyme, solute, alkali solute, antioxidation substance, organic solvent which have a reducing property that are thereafter added, another test is performed with another adding processes, and tendencies and effects were observed one by one in the classified ipomoea aquatica

The fourth problem to be resolved by the present invention is an application development of the ipomoea aquatica as the food additive and the processing agent. To resolve the problem, the excellent antioxidation ability of the ipomoea aquatica is taken into account, and for the purpose of using it in the purification process of highly unsaturated fatty acid such as DHA, EPA, and arachidonic acid, oxidized fish oil mixed with smashed fresh ipomoea aquatica or juice or substance extracted from the ipomoea aquatica is placed in a container to be sealed, shaken, rested and separated, with the results that the fishy smell removing effect of the fish oil and oxidized substance removing effect could be observed by using those extracted substances for washing.

Further as to the development of the ipomoea aquatica that is used as the functional food and the specified substance extracting material, extraction of substances from a freeze-dried product, an analysis of the contained substances by HPLC and detection of effective components within the contained polyphenol were commissioned.

Initially, the first problem to be resolved such as the distributing method of the fresh vegetables is described. It was possible to keep the ipomoea aquatica in a suitable condition as food through such processes where the cut surface of the stem portion is watered in additive-free water, kept for 10 days with the temperature between 0° C. and 5° C. under light shielding conditions and kept for 14 days with the temperature between 0° C. and 2° C.

The vegetables to be tested were laciniifolia, ipomoea aquatica, qing-geng-cai, garland chrysanthemum, peruviridis, and spinach. The test was conducted in such a manner that those vegetables were cut at a position near the roots, cleaned by water so as to remove all the soil crud, and inserted in a sealed container with somewhat larger quantity of water to prepared containers. One container included not only stem portions but also leaves that are being watered and removed from air to be sealed and the other container included only the cut stem portions. Then, the containers are kept under the condition with the temperature between 0° C. to 5° C. and being light shielded. Also, another test was run for the containers to be kept at the same time, the one container including stem portions of which cut portions were watered and kept at room temperature under light shielded conditions and the other container excluding the light shielded conditions.

Conventionally, the ipomoea aquatica is considered as not being suitable to be distributed under the temperature of equal to or less than 4° C. since the leaves of the ipomoea aquatica discolor below this temperature. However, in the test, the lasting shelf life period is confirmed in the case that the activities of the ipomoea aquatica are delayed by placing them under the condition at the lowest temperature at which the ipomoea aquatica would not be frozen while watering the cut surfaces of the stem portions of the ipomoea aquatica under the condition of being sealed, and at the same time, the case that the ipomoea aquatica is watered at the room temperature under the condition of receiving light and being sealed.

In terms of the ipomoea aquatica, this method is effective because the ipomoea aquatica has the excellent regeneration ability, so that when the cut surfaces of the stem portions are watered and kept at the room temperature, the cut surfaces of the stem portions absorb water to improve the shelf life. However, as a result of the test, it was found that, if the test was run under the light shielded condition, the leaves of the ipomoea aquatica turn yellow on the third day to undesirably loose the product value, whereas a favorable result showing that the method is effective as the lasting time elongating method was confirmed in the following cases that the stem portions did not turn yellow but last when the cut surfaces of the stem portions were watered and kept at the temperature between 0° C. to 2° C. for 14 days, and that the stem portions and the leaves did not turn yellow, although the infiltration into the leaves were found, when the stem portions and the leaves were kept at the same range of the temperature and thus the ipomoea aquatica after being kept for 14 days remained suitably crisp even after being heated.

For the sake of a comparative test, the same kinds of vegetables were kept in the air at 10° C. Almost all kinds of vegetables shriveled on the fourth day and became uneatable within 7 days. In this test, it was reconfirmed that the ipomoea aquatica does not have good preservation ability.

In terms of the vegetables other than peruviridis, the test was performed under the conditions at low temperature immediately before being frozen, light shielded and sealed. As a result of the test, at least one of the cases where the cut surfaces of the stem portions were watered or where the leaves in addition to the stem portions were watered with a large amount of water shows the similar tendency with the ipomoea aquatica. Therefore, it becomes possible for the peruviridis to be distributed to the region and the business realm that has been out of the distribution area since the lasting period was elongated for these vegetables for food of which leaves and stems were subjected to the heating process and which used to have a short distribution lasting period.

The second problem to be resolved such as the specification of the portions and kinds of the ipomoea aquatica suitable to be processed will be described hereinafter.

There are typically two types of classifications of the ipomoea aquatica in each country such as a classification into 2 classes according to the width of the leaf and a classification into two classes according to the growing method such as the water cultivation and the soil cultivation. Further classification into types according to the flower colors are seen in some countries; however, as the names and the enclosed areas vary in countries and many mixed species are seen due to the mixed community, the genetic differences and classifications are not well known and no attempt has been made for the already specified kinds to compare the discoloration after being heated.

The kind of narrow leaves resulting from the classification according to the width of the leaf is a generic name of the kind having leaves in which a length of the leaf is three times as long or longer than the width of the leaf, which is generally called the bamboo leaf (or bamboo-leaved) or green stem. However, even if this kind of ipomoea aquatica is grown under the same conditions, the shapes of the leaves will become various shapes as shown in FIGS. 1 to 6, i.e., there are leaves having a plurality of different features and the mixed species having different leaves on the same stem, and it is observed that these leaves will show different discoloration after being heated.

In the case where all the leaves on the same stem have the shape as illustrated in FIG. 6, those leaves, apart from the others, are hard to discolor after being heated or frozen, and further such a tendency is observed that the degree of the discoloration after being frozen or defrozen is small.

However, there are some among the leaves having the same shapes that easily discolor after being heated. Namely, some are found that may be the mixed species, although there is no sign in the shapes of the leaves.

Also, to the contrary, it is observed that such ipomoea aquatica hardly discolors after being heated where the ipomoea aquatica including leaves having the same shape as illustrated in FIG. 6 on the same stem, even if such shapes of leaves as illustrated in FIG. 5 are mixed therein. It is effective to selectively grow only such kinds of ipomoea aquatica that one stem includes only the leaves in which a curved line of the end portion of the leaf from the leaf end to the leaf top extends continuously from the leaf end toward the leaf top without creating projections.

To the contrary, the so-called wide leaf (or large-leaved) having wide width of leaf or white stem remarkably changes in color. Also, in general, the ipomoea aquatica including a plurality of leaf shapes as illustrated in FIGS. 1 to 4 remarkably changes in color after being heated, although there is a difference in the degree of discoloration.

Consequently, the ipomoea aquatica including the leaves as illustrated in FIG. 6 and the ipomoea aquatica including the leaves as illustrated in FIGS. 6 and 5 which hardly discolor are selectively cultivated and thereafter the roots are identified to observe the degree of the discoloration due to the heating process of the harvested stems. Then, the roots that hardly discolor are selectively cultivated in order to exclude the roots having different genetic features with regard to the discoloration after the heating process despite having the same shaped leaves. As such, it becomes possible to collect the ipomoea aquatica suitable for being processed that hardly changes in color even where subjected to the heating process or the freezing process.

Further, although there are differences in degree of changes in color according to the kinds of the ipomoea aquatica, there is commonly seen an apparent difference in the discoloration of the stems and the grown up leaf stems after being heated and there is commonly seen an apparent difference in the degree of the discoloration after being heated of buds, the leaves having young leaves near buds and leaves having the grown up leaf stems at positions away from the bud. Accordingly, in the sense apart from that the product characteristic is determined as a result of processing only leaves by simply classifying the portions as done conventionally with the spinach or the like, the purpose of removing the portions which were found to be prone to discolor in the test in order to prevent such portions from the discoloration while being processed, only the leaves and the leaf stems thereof which satisfy certain requirements were selected to be subjected to the processing, and therefore, it was found that the realization of the product involving a new additional value in which the degree of the discoloration of the product after being heated was suppressed.

The ipomoea aquatica sold in the market includes the following composition rate fluctuation, 1 kg of mixed species that mainly include the wide leaves and which are prone to discolor remarkably and thus are difficult to confirm of their effect are classified. Thus classified ipomoea aquatica is checked of its composition rate as being 30% of stems, total 20% of buds, two young leaves and their leaf stems and total 50% of leaves having leaf stems other than the above mentioned and the leaf stems thereof. Then, the ipomoea aquatica is to be subjected to the blanching for 1 minute and thirty seconds at the temperature between 98° C. and 100° C., respectively, followed by an instant cooling by water and a comparison of the discoloration to find out whether regenerated leaf stems and their leaves showed the degree of discoloration different from the degree of the other portions.

Specifically, the ipomoea aquatica including the above stated leaves having the shapes as illustrated in FIG. 6 or FIG. 6 and FIG. 5 showed a small degree of discoloration in their entirety, and the grown up leaves and the leaf stems thereof did not significantly show a brown spot or a black spot. Therefore, it becomes apparent that producing the ipomoea aquatica processing product that does not discolor can be achieved if those kinds of ipomoea aquatica were selectively collected.

The third problem to be resolved by the present invention is a method for suppressing the discoloration and change in quality due to the processing. Adding ethanol was effective as such a method and it was confirmed that adding amino acid such as glutamic acid was slightly effective for maintaining the color of the ipomoea aquatica.

Especially, ethanol, if the ipomoea aquatica after being heated is subjected to an instant maceration into a solution mixed with the ethanol, a green color of the leaves, the leaf stems and stems become brighter compared to those without the addition of the ethanol. Also, it was observed in the ipomoea aquatica that was frozen after being added with the ethanol that an apparent effect that crinkles, occurring specifically on the stems, did not occur.

In terms of the effect of the ethanol, i.e., prevention of the discoloration, the effect varies depending on the kinds of ipomoea aquatica. However, as common to every kind of the ipomoea aquatica, effects were seen in preventing the discoloration and in turning the color of the leaves into fresh green, and differences due to the difference of the kinds of the ipomoea aquaica were not viewed in terms of the crinkles but similar effects were shown commonly.

In connection with the other discoloration and improvement of color of the leaves, the degree of the change was affected by the type of the ipomoea aquatica; however, it was confirmed that the hardness of the processing water such as cooling water, glaze water and the like, pH, oxidation reduction potential and dissolved oxygen also affected the discoloration and improvement of color of the leaves.

Further, it is known that the maceration into the amino acid solution and adding of glucommannan and oxalic acid produce such effects by repeating the freezing process and the defreezing process that a good affect to the color after being frozen can be seen gradually compared to the processing water composed only of water.

The fourth problem to be resolved by the present invention is the application of the ipomoea aquatica to the food additive and the processing acid. It was confirmed by the following simple method that the application to the purification of fish oil is effective.

The method includes the processes where uneatable portions such as fish wing and midrib of fish without internal organs and gills were simply heated to be resolved so as to allow the fish oil to be smelled with suitable fish smell and oxidized smell, the fish oil being oxidized to some level, the fish oil and an extract obtained by mashing the ipomoea aquatica, with the extract being mixed with water of the same weight and being filter-pressed for a short period of time, were mixed at a volume rate of fish oil:extract=1:6 The mixture of the fish oil and the extract was placed in the container to be sealed and shaken drastically to mix them up, the mixture was kept for one day at 5° C. in order to allow the mixture to separate into water layer and oil layer, then the container was opened to confirm the smell, and the mixture was sealed again to be shaken to allow the mixture to separate as stated above and confirm the smell again, resulting in repeating the same task four times.

As for the comparison, a similar confirmation test was run by adding water instead of the extract to the same fish oil with a volume rate of fish oil:extract=1:6.

In the initial confirmation, an apparent difference was not found, but the difference appeared on and after the second test and there was almost no fish smell upon the fourth confirmation, which shows the smell removal effect of the extract using water. Further, no bleaching effect was shown in the test but oxidized substance removing effect could be observed.

According to a method as set forth below, extraction of polyphenol such as chlorogenic acid was detected, which showed that polyphenol exerts an antioxidizing effect on the fish oil and also showed that the antioxidizing effect could be obtained by the extract using water or the extract using organic solvent better than the ipomoea aquatica.

Further, with regard to the functional food, it was confirmed that the ipomoea aquatica contains caffeoylquinic acid derivative and, more specifically, such caffeoylquinic acid was more contained in leaves than the stem portions according to a method disclosed in the following examples.

This substance is tricaffeoylquinic acid for suppressing activities of HIV, of which, however, the amount contained at present is not large. The ipomoea aquatica has been supplied and easily obtained around Africa and south-east Asia for years, where a rate of AIDS is high, is of the excellent regenerate ability and of extremely fast growing speed so that a rapid increase of production can be achieved, and further there is dietary habit around these areas. Therefore, the tricafeoylquinic acid will become the effective extracting material since, thanks to the ipomoea aquatica, tricafeoylquinic acid can be obtainable in different seasons and in different regions where the leaves of sweet potatoes from which the same substance has been detected.

Further, other than the above, it was found that the ipomoea aquatica contains caffeoylquinic acid which draws attention for the reason it has an antimutagenicity which is coming under the spot light in the polyphenol such as chlorogenic acid and dicaffe oyquinic adic (3,5-decaffeoyquinic acid).

Still further, in terms of the problem to be resolved by the present invention of how to provide the ipomoea aquatica under a status of the frozen preservation or the normal temperature preservation without lowering the antioxidation ability, it is necessary that the lowering of the antioxidation ability and the discoloration are prevented by preventing the antioxidation in the course of the processing of the contained polyphenol or while the preservation of the product in which orthoquinone is generated due to the oxidization of polyphenol and in which polyphenol compound and iron react to produce ferrosoferic.

The antioxidation of the polyphenol as stated above requires an enhancement of the reducing power in an active manner, in view of the oxidization to some extent which occurs due to the oxidization while processing and a contamination of metal ion, with respect to the enzyme deactivation according to the blanching and the shielding of the enzyme according to the glazing as the conventional art for suppressing the oxidization.

Especially important are the quality of water which always is in contact with the object processed food or which is absorbed by the object processed food in the course of the processing, and the lowering or eliminating of the metal ion and the dissolved oxygen which are caused by a quick deactivation of the polyphenol oxidase, processing device and water.

The oxidization of the polyphenol in the object processed food is considered to have a large affect on strong acid ions such as sulfuric acid and nitric acid, presence of cholorine and oxygen, presence of iron and copper and a valence number of ion, pH and the oxidization reduction potential. Therefore, water to be used in the blanching process, water to be used in the course of the cooling process in which cooled water is absorbed into the object frozen material and glazing water to be contacted with the object processed food for a long period of time after being frozen are required to be selected for checking the quality of the processed water taking the above stated matter into consideration.

Specifically, in the case where the ipomoea aquatica containing a specific polyphenol such as chlorogenic acid and the ipomoea aquatica containing a large amount of iron are processed, it is necessary to prohibit the reaction by using the low oxidization reduction potential water in the process since cells are destroyed during heating or freezing and iron that is in contact with polyphenol can not be removed.

It is also effective to use water in which the strong acid ion such as sulfuric acid and nitric acid, a specific metal such as iron and copper, the dissolved oxygen and chloride are removed or reduced.

For the purpose of suppressing the oxidization of polyphenol, the use of alkali water is also effective. However, it is required to do a prior check of the contained component of the object processed food, the containing component and added component of the processed water, and the compatibility between them since some of the contained components of the object processed food discolor due to alkali property and others discolor due to a reaction with the chloride.

As for the considering method, such method will be simple that the raw materials are washed carefully, additives for the sake of adjusting water quality and water to be used are added to mash the material under the condition of no oxygen, then the resulting product is placed in the container and sealed without oxygen to observe the discoloration as time passes.

Especially, in the case of processing the ipomoea aquatica or perilla frutescens, which shows remarkable discoloration, it is preferable to use water so made that distilled water except for initial boiled water is added with weak acid such as baking soda, natrium, kalium, calcium salt and excludes strong acid ion, iron and copper, water of low oxidation reduction potential and water of low dissolved oxygen.

It is also effective to mash the object vegetable in order to destroy cells thereof after being heated and frozen without digesting the raw material by adding a digestive enzyme, thereby being capable of avoiding the addition and use of an acid or base for adjusting pH in connection with the enzyme and of contributing to a prevention of contamination of impurities contained in the enzyme and oxide.

If the ipomoea aquatica is processed keeping its original form, buds and stems show partial discoloration, whereas if the ipomoea aquatica is subjected to extraction and mashing, such portions will be mixed with green leaves relatively stable in color and thus the colors are harmonized to show uniform color to finish up into the product having the color without oddities.

Further, the ipomoea aquatica extracted using ethanol of high density or the ipomoea aquatica mashed after being macerated show fresh green color, thereby providing the extract having good product value.

To the contrary, it is also effective to spray liquid nitrogen or dry ice onto the ipomoea aquatica or to macerate the ipomoea aquatica with the liquid nitrogen or ethanol at the low temperature in order to freeze the ipomoea aquatica in a rapid manner to reduce the cell destruction as much as possible, resulting in suppression of contact between the polyphenol and the metal. In such a case, it is further effective, while keeping the antioxidation ability of the polyphenol, to preserve the ipomoea aquatica under a high freezing rate or to preserve the ipomoea aquatica by vacuum drying without mashing and thereafter removing oxygen.

Recently, the ipomoea aquatica draws attention thanks to decontamination of the water of lakes and ponds, and therefore, the ipomoea aquatica gradually becomes more produced in Japan; however, it is impossible for the ipomoea aquatica to be preserved by frozen storage and thus can be supplied only within a limited period of time. Namely, only a small production amount is secured.

The ipomoea aquatica have been produced in large amounts and inexpensively in warm countries, but have not been commercialized since the ipomoea aquatica changes in color in the course of processing or preserving. In order to resolve this problem in view of the business field, various tests have been conducted but no satisfactory result could be obtained.

In the present test, the causes of remarkable discoloration as represented by the discoloration of the ipomoea aquatica and leaves of sweet potatoes are not limited to the oxidization of the contained metal ion or the oxidization according to the enzyme as considered conventionally, but attention is drawn to the polyphenol reaction which still progresses after being heated, the reaction exemplified as the oxidization of the polyphenol which remains after heating processing and the generation of the compound composed of the polyphenol and the metal ion. Accordingly, the present invention developed a method for avoiding this reaction, and therefore, makes it possible to effectively process and preserve the peculiar and high polyphenol raw materials that have been considered as being unsuitable to be processed.

Especially, it is effective that the ipomoea aquatica grows up in a short period of time, regenerates from the root remaining in the soil, can be water cultured, is excellent in decontamination of water of the lakes and ponds, and is known in China and Taiwan for their high nutrition and can provide physiologic effect by being eaten. Disregarding that the ipomoea aquatica is such an excellent food material, commercial production has not been made due to the discoloration. In view of the above, it is fortunate that such an excellent food material came to be commercially produced.

With regard to the growing of the ipomoea aquatica in Japan, an expansion of the use of the ipomoea aquatica will provide an expectation of consumption thereof, and the expansion of production will further facilitate the decontamination of water. The advantageous result according to the present invention contributes to a wide range of fields.

According to the test run at the same time of what is done for the ipomoea aquatica, the vegetables containing a large amount of polyphenol such as perilla frutescens leaves and garland chrysanthemum showed similar tendencies as the ipomoea aquatica

The present invention, in view of the actual production process, is made to be a practicable device by running tests mainly using the distilled water or the electrolytic water, which are available or produceable in any area, with regard to natural water of the region.

Therefore, purchasing the suitable water or being equipped with facilities for distillation and producing electrolyte water will enable the commercialization of the frozen products in various areas. As a result thereof, a vast amount of supply of the raw materials and the low prices thereof make it possible to supply products that are excellent in antioxydation with low price.

The present invention is effective in that wine and cocoa having antioxidation tend to be recognized as the product property, it is assumed that the same tendency will show up in the frozen vegetables, and there is a possibility of causing a product gap due to the antioxydation ability between the producers and between the lots. Especially, the ipomoea aquatica processed product and the ipomoea aquatica extract, which suppress the discoloration in the present invention, contain a lot of polyphenol and have excellent antioxidation ability, and will become the food in which interest will increase.

According to the present invention, the large amount of specific polyphenol contained in the ipomoea aquatica, which is a factor in preventing the commercialization of the ipomoea aquatica, is considered as the excellent product property having the strong antioxidation property and active oxygen removing ability, by shifting the perceptional idea. As such, the present invention provides the products that contribute to the human health thanks to the processing method which keeps the above mentioned property, thereby enabling the processing and the use of the ipomoea aquatica that have not been processed in the past.

As stated above, the ipomoea aquatica is an excellent food, grows in the warm areas in a short period of time, regenerates from the remaining root, can be subjected to water cultivation, can decontaminate water in lakes and ponds, and is rich in nutrition; however, the ipomoea aquatica has not been used due to its discoloration while being processed. It is advantageous that such excellent food becomes capable of being commercialized.

Further, while the secondary product from the agricultural products such as leaves and stems of beans include a large amount of various types of polyphenol, there are a lot of examples in which polyphenol is thrown away since there is no eating habits for such a secondary product that is normally treated as plant food and animal food. According to the present invention, in order to enable the secondary products to be extracted of their polyphnol and thereafter to be used as the plant food or the animal food, the antioxidatin ability of the contained polyphenol is kept without the unfavorable additives as much as possible. It can be expected with the present invention that these secondary products of the agricultural products be utilized effectively.

Also, while the collection of the raw materials is difficult and thus the collection thereof becomes unstable, the cost thereof becomes high and the quality thereof becomes unstable since a lot of raw materials for extraction utilize peculiar breeds and peculiar portions, the ipomoea aquatica used as the raw material in the present invention can be supplied in good freshness, at low cost and in large amounts because of the low growing cost in the warm areas, a large amount of supply due to the strong regeneration ability and the distribution system already having been established in the field of fresh vegetables. Further, the secondary products thereof are inexpensive and can be obtained in large amounts and at low prices, although they are harvested in a short period of time.

Further, since the raw materials can be collected with ease, the supplying amount and the cost can be reduced, the production processes can be simplified and the processing facilities can be reduced, and the resulting products can be provided at low cost.

Further, since the decontamination ability of the ipomoea aquatica with regard to lakes and ponds came to be known, the ipomoea aquatica came to be produced recently in Japan. However, since it is impossible for the ipomoea aquatica to be subjected to the frozen storage and the processed use, the distribution thereof is limited to a market supply in the form of fresh vegetables during summer season of high temperature and to a greenhouse cultivation which is more costly. Further, the producing amount is small.

According to the present invention, an expansion of demand of the ipomoea aquatica can be expected owing to the expansion of processing applications with regard to the cultivation of the ipomoea aquatica in Japan. Further, the more cultivation of the ipomoea aquatica is facilitated, the more the decontamination of water in Japan will progress, i.e., the present invention contributes to the improvement of the environmental decontamination.

Upon processing the ipomoea aquatica, it is effective to add the oxalic acid or oxalate when processing the ipomoea aquatica, since the remarkable suppressing effect in the discoloration can be seen. In the case that the oxalic acid is added as the food additive, it is obliged that the oxalic acid should be removed before finishing up the final product in Japan. On the other hand, some of the food includes a large amount of oxalic acid, such typical food being exemplified as spinach and arum root. Such methods where the processing is performed together with these foods or that the processing is performed using the extract of these food are also effective.

A remarkable discoloration was suppressed in such a manner where the ipomoea aquatica is subjected to the blanching with water containing oxalic acid or oxalate and subjected to the subsequent cooling. When the ipomoea aquatica, once turned brown or partially black, is subjected to the blanching with water containing oxalic acid or oxalate and subjected to the subsequent cooling, the degree of the discoloration is reduced. As stated above, the treatment with water containing oxalic acid or oxalate showed the remarkable effect in reducing or suppressing the discoloration. Accordingly, the discoloration according to the processing of the ipomoea aquatica was suppressed and thus the commercialization of the ipomoea aquatica with product value was realized.

The ipomoea aquatica in the warm areas grows in a short period of time, regenerates from the remaining roots, can be subjected to water cultivation, is excellent in decontamination of water in lakes and ponds, and can be supplied in large amounts and at low cost, and therefore further increased production of the ipomoea aquatica is possible thanks to the easy cultivation thereof.

The ipomoea aquatica is an alkali food rich in polyphenol or the like, has an excellent antioxidation property, and is excellent in nutritional value. The ipomoea aquatica is the excellent food material to the extent that the physiologic effect when intaking it has been officially announced in China and Taiwan.

According to the present invention, it is extremely effective that the supply of the ipomoea aquatica becomes capable, because the ipomoea aquatica can be preserved with the discoloration due to the processing being suppressed, can be supplied constantly at low cost and in large amounts, and has rich nutritional value.

### BRIEF DESCRIPTION OF DRAWINGS

FIG. 1 illustrates that, among ipomoea aquatica forsk of a kind of narrow leaf width (bamboo leaf), there is a projection of a round shape on a leaf portion near a leaf base on the right side or left side of the leaf base or both sides of the leaf base.

FIG. 2 illustrates that, among ipomoea aquatica forsk of a kind of narrow leaf width (bamboo leaf), there is a projection or a dimple of a sharp angle on the leaf portion near the leaf base on the right side or left side of the leaf base or both sides of the leaf base in which the leaf has a triangular shape in its entirety.

FIG. 3 illustrates that, among ipomoea aquatica forsk of a kind of narrow leaf width (bamboo leaf), the leaf portion to be joined with the leaf base has a straight line shape and the leaf has a triangle shape having a sharp angle in its entirety.

FIG. 4 illustrates that, among ipomoea aquatica forsk of a kind of narrow leaf width (bamboo leaf), the ipomoea aquatica of the extremely narrow leaf width, the ipomoea aquatica including a bulge near the leaf base in a manner enclosing the leaf base, or a bulge projecting toward the other direction than a leaf top on one of the right side or left side or on the both sides, an entire leaf shape of the ipomoea aquatica being of an arrow shape or of a sagittate shape, and the ipomoea aquatica having the extremely narrow leaf width among the ipomoea aquatica of a kind of wide leaf (wide leaf) of the ipomoea aquatica of the arrow shape.

FIG. 5 illustrates an example of a leaf having a shape in which a curving line from the leaf base to the leaf top continues from the leaf base to the leaf top without the projection, in which, among the ipomoea aquatica forsk of a kind of a narrow leaf (bamboo leaf), that the leaf portion contacting the leaf base is a straight line and, different from FIG. 3, the entire leaf shape is not the triangle shape but is close to a bamboo leaf shape.

FIG. 6 illustrates an example of a leaf having shape in which a curving line from the leaf base to the leaf top continues from the leaf base to the leaf top without the projection, in which, among the ipomoea aquatica forsk of a kind of a narrow leaf (bamboo leaf), that the entire leaf is of a shape of bamboo leaf in which the leaf portion near the leaf base has a round shape with the leaf base being a top of the round shape.

FIG. 7 illustrates examples of a stem, a young leaf, a leaf stem and a leaf of the ipomoea aquatica foresk of a kind of wide leaf width (wide leaf) before being heated, in which the portions that show a remarkable discoloration after being heated is illustrated in black.

### PREFERRED EMBODIMENTS

As to the first problem to be resolved by the present invention such as the distribution method of the ipomoea aquatica as the fresh vegetable, it is preferable for the ipomoea aquatica to be kept at the temperature closest to 0° C. provided that the temperature is continuously kept at equal to or above 0° C. since the ipomoea aquatica changes in color to dark green as well as being intenerated due to the destruction of cells at all the portions starting from the leaf portions even once the ipomoea aquatica is frozen.

If the ipomoea aquatica is macerated up to the leaf portion, it is expected that water permeates into the leaf portion to make the leaves turn dark green in color and thus product value of the ipomoea aqatica is lowered in view of the appearance thereof even if there is no difference in crispness after being heated. Therefore, it is preferable that only the cut surfaces of the stem portions are macerated and placed generally in a horizontal position for the sake of preservation the ipomoea aquatica without the leaf portion being macerated.

Further, such factors as a careful wash of vegetables, prevention of the contamination of bacillus thuringiensis as much as possible, using a vast amount of water containing as few viable cells as possible, adding the substances having an antibacterial action to the water, keeping the temperature immediately before the water is frozen and a complete light shield are important for elongating the available preservation period.

Still further, as to the preservation at the room temperature by macerating the cut portions in water, preservation for a long period of time was possible owing to the excellent regeneration ability of the ipomoea aquatica. However, if the light is shielded here, the ipomoea aquatica changes in color to yellow on the third day. Therefore, the preservation at the room temperature is done while supplying light, and the low temperature water supply preservation is done while shielding the light.

As to the second problem to be resolved by the present invention such as making the portions hardly discolor, it is preferable that the confirmation is done in such a manner that two young leaves and their leaf stems of stems, buds or in the vicinity of the buds are separated to leave only the grown up leaves and their leaf stems, the remaining leaves and leaf stems are subjected to the blanching for 1 minute and 30 seconds at the temperature between 98° C. and 100° C., the leaves and the leaf stems are macerated in cooled water several seconds after the blanching in order to completely block the leaves and the leaf stems from the air and cool them down, and thereafter the removed portion is compared to the portions subjected to the similar treatment to observe the difference in discoloration after being heated between the grown up leaves and the young leaves and buds, and between the grown up leaf stems and the grown up stems.

Here, a period of time on the second time scale after the blanching and to the cooling is the most important. In addition thereto, it has to be noted that the discoloration will progress according to a trivial matter such as the temperature of the blanching, lack of time or nonuniformity of the period of time, and contact with the air over the water while being cooled after the blanching. Also, such cases have to be noted that a contamination of the portions which are required to be removed will make it difficult to precisely observe the differences of the discoloration between the two after being heated as the contamination rate increases, and the addition of the ethanol as will be stated later enables brightening of the leaves and the stem portions to a certain degree such that a difference between the dark green color and the brown color of the leaves and the stems should be clearly distinct.

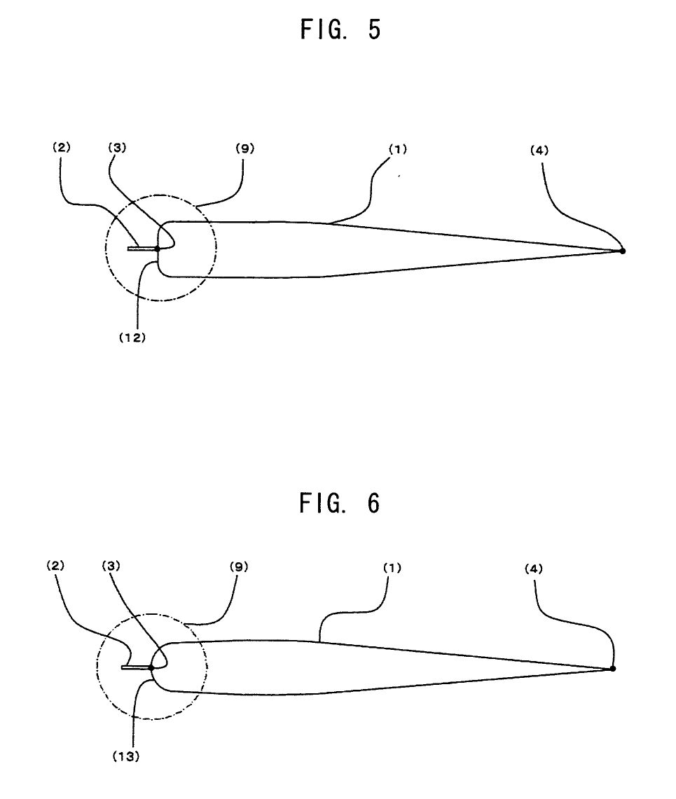

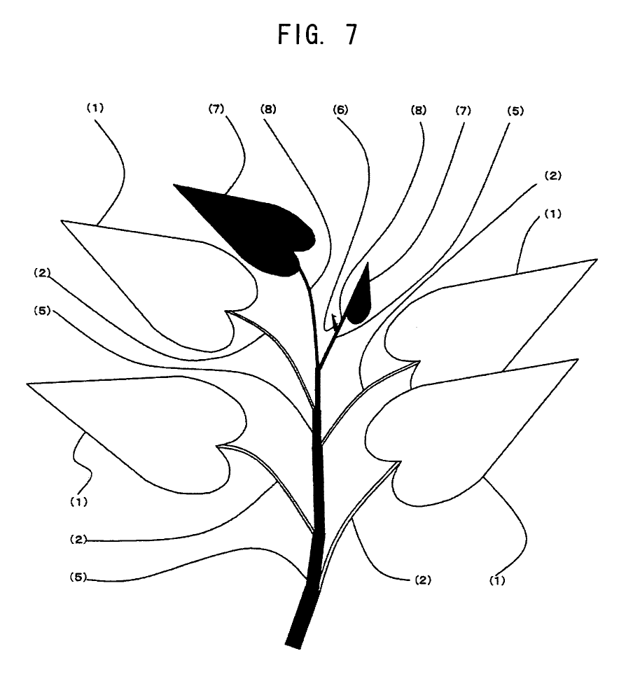

The portions which hardly discolor show a similar tendency disregarding the kinds of the ipomoea aquatica, whereas the ipomoea aquatica of the wide leaves which changes in color remarkably shows the less degree in the discoloration in comparison with the other portions of the same kind as far as with regard to the specific portions, but shows a greater degree of discoloration in comparison with the same portions of the other kinds. Accordingly, the mixed community of each of the mixed species of the kinds of narrow leaf width as much as possible will become a final product having good color. Further, it can be observed that the ipomoea aquatica having the leaves as illustrated in FIG. 6 as stated below and having the leaves as illustrated in FIGS. 6 and 5 on the same stem will show a lesser degree of discoloration after being heated, and the leaf stems and the leaves derived from there will show almost no discoloration after being heated.

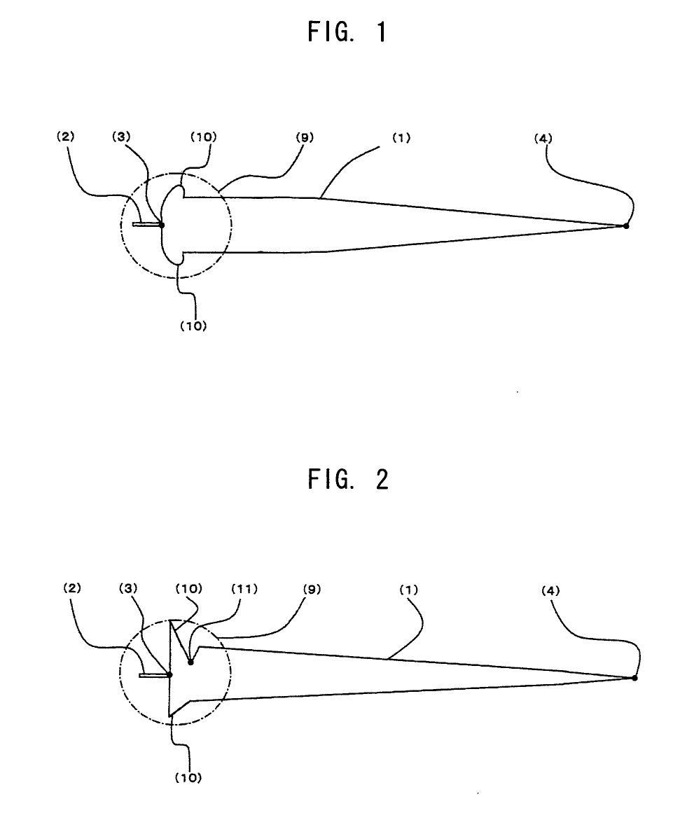

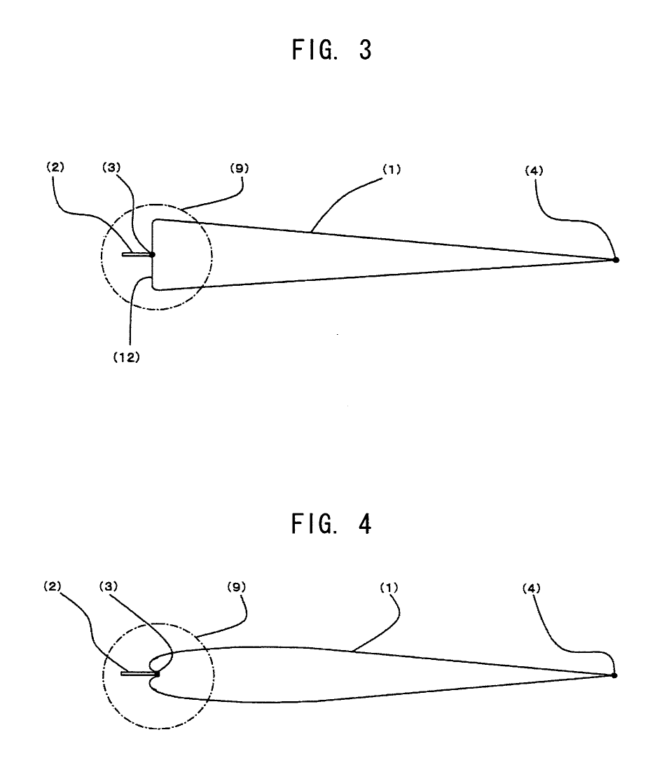

With regard to the kinds that hardly discolor after being heated and the cultivation thereof, the wide leaf (or the large-leaved) having wide width of the leaf or the so-called white stem show a remarkable discoloration after being heated. Among the bamboo leaves (or bamboo-leaved) having narrow width of the leaf or the so-called green stem, the ipomoea aqatica having the leaf shape in which there is a projection in the vicinity of the leaf base as shown in FIGS. 1 and 2 will readily discolor. Regarding FIGS. 1 to 6, 1 denotes a leaf portion, 2 denotes a leaf stem of the leaf portion (1), 3 denotes a leaf base, 4 denotes a leaf top, 5 denotes a stem, 6 denotes a bud, 7 denotes a young leaf, 8 denotes a leaf stem of the young leaf (7), 9 denotes an area of a circle with a radius 3.0 cm from a joining portion between the leaf base and the leaf portion, 10 denotes a projection of the leaf potion, 11 denotes a dimple of the leaf portion, 12 denotes a portion featured where a straight line shape of the leaf portion joined with the leaf base, and 13 denotes a portion featured in that a round shape of the leaf portion, a top of the round shape being the leaf stem, respectively.

On the other hand, among the kinds that hardly discolor as stated above, the kind only having the leaves as illustrated in FIG. 6 on the same stem shows less discoloration. However, there is a possible existence of a kind which has a genetic tendency for a greater degree of the discoloration, although such does not appear in the shape of the leaves, and also there are some that actually show the degree of discoloration different from the other kinds. Therefore, it is preferable to select a plurality of roots that show less discoloration after being heated in terms of the stems that are identified and harvested in order to increase them, those selected roots are confirmed in the same way to gradually and periodically exclude the mixed roots.

Since the ipomoea aquatica grows very fast under the circumstances of high temperature and high humidity and has the excellent regeneration ability which regenerates from a remaining stem of a length of several cm above a root, the ipomoea aquatica can achieve an alternation of generations faster than the other plant, which is effective for the exclusion of the mixed species as stated above but which invites a high possibility of contamination of different species from the outside, such that an isolated cultivation is preferred for the ipomoea aquatica.

With regard to the third problem to be resolved by the present invention such as the discoloration and the change in quality as a result of the processing thereof and the method to suppress the change in quality, it is preferable for the ipomoea aquatica to be macerated in the ethanol solution as already described.

As a maceration method, it is to be noted that the ipomoea aquatica is macerated for 1 minute and 30 seconds at the temperature of between 98° C. and 100° C. in a manner avoiding bruises due to load of leaves, thereby deactivating the enzyme, immediately thereafter, within 3 seconds if possible, the ipomoea aquatica is macerated into the ethanol solution and submerged in such a manner that no portion of the object macerated material will come up over the surface of the water in order to cool and macerate the ipomoea aquatica.

Here, the density of ethanol is between 3 to 5 vol %. However, the higher the density of the ethanol becomes, the more the effect is produced preventing the discoloration and in suppressing the crinkles. In an extreme case, absolute ethanol is the most preferred. In the actual process, the density of the ethanol is adjusted to be between 3 to 5 vol % considering the actual processes and cost, and ethanol smell and taste upon using it for food. If only observing the effect, the density of between 10 to 20 vol % will show the result more clearly.

With regard to the prevention of crinkle occurrence when the ipomoea aquatica is defrosted after being heated or frozen, the prevention of the discoloration and observation of the fresh green color of the leaf portions, the effect can be observed more clearly if following such processes where the ipomoea aquatica is prevented from contacting the air immediately after the blanching, the ethanol solution is used for the ipomoea aquatica to be cooled therewith immediately after the blanching utilizing the permeation of the ethanol under favor of shrinking of the object processed material due to cooling down, the ipomoea aquatica is subjected to a block freezing under the condition that the ethanol is supplied, and then the ipomoea aquatica is unpacked after being defrosted.

Especially, the discoloration after the blanching occurs quickly, and once there occurs the discoloration, the color would not return to the original color even after the maceration. That is to say, the ipomoea aquatica of the kind that discolors less is under a state prone to discolor even slightly after the blanching. Therefore, it is important to block the ipomoea aquatica, not only the kind of the ipomoea aquatica that remarkably discolors, from the contact with the air as immediately as possible after the blanching and before macerating into ethanol, oxalic acid, amino acid solution or the like to suppress the discoloration. It is also effective to prevent the crinkles from occurring by macerating the ipomoea aquatica in a mixed solution of the ethanol together with phosphate, organic salt and the like having moisture holding effect.

With regard to the fourth problem to be resolved by the present invention such as the food additives, it is found that the ipomoea aquatica is effective for the purification of the fish oil. Accordingly, the purification can be done simply and optimally by the following method.

The best method for removing the smell of the fish oil and the oxide includes such processes where, initially in order to reduce the degree of oxidization of the fish oil, herrings are boiled down to extract the fish oil, the fish oil is subjected to a filter press with water of the same amount with respect to the mashed ipomoea aquatica, the quickly extracted extract is added to the fish oil with the volume rate of fish oil:extact=1:6 to be placed in the sealed container and shaken drastically in order to mix them up, then the mixture is kept for one day at 5° C. to allow it to separate into the water layer and the oil layer, thereafter the container of the mixture is opened to confirm the smell of the mixture and is resealed, and the container is sealed to be shaken to allow the mixture to separate again and the smell of the mixture is confirmed, such task being repeated for four times.

If the fish oil to be used is less oxidized, the antioxidation ability of polyphenol contained in the ipomoea aquatica extract will work more effectively to achieve the purification of the fish oil for lesser smell and lower acid value and peroxide value.

As a matter of course, a better result is obtainable if the extract is substituted with a new one every time the smell of the fish oil is confirmed.

Again, in the fish oil producing countries in south-east Asia having canning factories, ipomoea aquatica is obtainable in large amounts and at low cost, extraction can be done with ease through water extraction, and thus a large amount of extract is usable at low cost. Therefore, in view of the cost performance, the extract can be used at the initial phase of fish oil purification as well as the water wash of the fish materials which are damaged by the heating process. In the actual processes, it is preferable that a process to rewash the fish material with the extract is done after the water wash process to clean up the fish oil materials, followed by centrifugal separation, wintering, distilling and the like.

It is considered as being effective that the ipomoea aquatica extract is purified to make a solution, with the antioxidation ability remaining, and the solution is used for the washing process of the removal of smell and oxide at a step before the distilling, thereby enabling the reduction of the fish smell.

With regard to the confirmation of the presence of the effective component as the functional food, it is preferable to confirm if the effective component is contained or not by the method equivalent to the following method in which the extraction and the test was done.

The test was run with a sample of freeze dried product of the mixed species of the ipomoea aquatica under the conditions that: column is inert sil ODS 3(4.5×250 mm)5 μm, mobile phase A is water:acetonitrile:acetic acid=90:10:0.1, mobile phase B is water:acetonitrile:acetic acid=55:45:0.1, first stage A:B=isocratic 100:0 (10 min. hold), second stage A:B=isocritic0:100 (10 min. hold), velocity 1 ml/min. and UV detection at 320 nm.

### EXAMPLE 1

At first, the first problem to be resolved by the present invention such as an elongation of the lasting preservation period of time for vegetables including the ipomoea aquatica will be described hereinafter.

Paying attention to the fresh ipomoea aquatica so as not to give an damage thereto, the ipomoea aquatica is carefully washed with water so as to remove all the soil cruds, the cut surface of the stem is cut again in a clean condition, water containing the fewer number of cruds is supplied in a manner making sure that the cut surface is macerated with water and is kept in a light shielding condition at the temperature between 0° C. and 2° C., and kept in a status allowing the ipomoea aquatica to be placed in a general horizontal direction, thereby preserving the ipomoea aquatica.

Accordingly, it can be observed that the preservation lasting period of time of the ipomoea aquatica, which used to be preserved only for several days due to the rapid lowering of the freshness thereof, is elongated to more than 10 days.

Then the second problem to be resolved by the present invention such as the specification of the portions and kinds suitable for the processing of the ipomoea aquatica will be described hereinafter.

With regard to the portions, a constant tendency can be observed in such a test where the mixed species of the ipomoea aquatica mainly including the bamboo leaves are separated into three groups such as stems and buds, and two young leaves in the vicinity of the buds and the leaf stems thereof, and the grown up leaves and leaf stems thereof, the blanching is performed on each of the groups for 1 minute and 30 seconds at 100° C. in such a manner to avoid making bruises on them, each group is cooled with water immediately after the blanching to observe the degrees of the changes in color of the stems, leaf stems and leaves among those three groups, and the above mentioned processes are done using a plurality of specimen materials.

Here, it is presumed that a difference in effectiveness of the effect will occur due to the difference of leaf widths, the difference of the leaf shapes as illustrated in FIGS. 1 to 6 and the difference of the cultivation circumstances, which used to be the factors that complicated the problem as well as leading to a result of the test to an erroneous direction, thereby hindering the resolution of the problem. Therefore, in comparing the results, it is preferable to use the ipomoea aquatica harvested and cultivated at the same area in the same season by selecting the ipomoea aquatica in accordance with the shape of leaves. The test is also run using the ipomoea aquatica of the other kind, the test is run on the plurality of kinds of ipomoea aquatica a plurality of times to observe a presence of a constant tendency between the degree of the discoloration and the portions.

Further, the young leaves in the vicinity of buds includes two such types that one shows remarkable discoloration and the other shows the discoloration as much as that which occurs on the other grown up leaves; however, taking the color of the final product into consideration, 2 pieces of young leaves are selected. Also, the ipomoea aquatica, in which more than 6 pieces of leaves including leaf stems are derived from the same stem, sometimes includes the third young leaf that shows more discoloration; however, since such cases do not happen frequently, it is unnecessary to remove such a third young leaf.

In view of the above, the ipomoea aquatica is subjected to a process such as blanching without cutting the ipomoea aquatica portion by portion, and it is thereby possible to observe the differences of the changes in color portion by portion of the plurality of sample materials having different shapes of leaves.

At the same time, it is also possible that a plurality of ipomoea aquatica of the kind having the leaf shape as illustrated in FIG. 6 among the mixed species are selected, such that the differences of the changes in color after being processed through blanching can be observed with respect to the ipomoea aquatica having the other leaf shapes.

Here, it is to be noted that a plurality of test are run with regard to the ipomoea aquatica having the leaf shape as illustrated in FIG. 6 in order to confirm that there are exceptions in the mixed species.

The third problem to be resolved by the present invention, such as the method for suppressing the discoloration and change in quality caused during the processing step of the ipomoea aquatica, includes a test under such conditions equivalent to the comparison test where the density of ethanol is adjusted between 10 to 20 vol. % in order to clearly show the effect thereof, the ethanol solution and cooled water to be used for a comparison are used to, as stated above, run a test paying careful attention to the differences of kinds according to the shapes of leaves of the ipomoea aquatica, the differences of the production area, the differences of the degree of freshness, and the period of time before the ipomoea aquatica is subjected to the blanching and the cooling process.

Further, in this confirmation test, the ipomoea aquatica is placed in the sealed container with the cooled water used in the test to remove the air and keep it in such a manner that even a portion of the object frozen material does not contact the air. Thereafter, the ipomoea aquatica is frozen 48 hours later to observe the difference between the two with regard to the colors of the leaves, leaf stems and crinkles of the stems.

Here, care should be taken when selecting the specimen materials since it is presumed that an accurate tendency is not obtainable, such that the same conditions should be given to the test object and the blank object, with the ipomoea aquatica of the different shapes of leaves being prepared.

With regard to the fourth problem to be resolved by the present invention such as the application of the ipomoea aquatica for the use of the food additives and processing agent, the applications of washing and purifying in the process of producing the fish oil is described.

The method for removing the smell and the oxides of the fish oil includes such processes where the herrings are boiled to be extracted in order to reduce the oxidization considering that the fish oil used by domestic fish oil purification companies collect the fish oils having good qualities, the fish oil and the mashed ipomoea aquatica is filter pressed together with water of the weight equal to the mashed ipomoea aquatica, the quickly extracted solution is added thereto by the volume rate of fish oil:extract=1:6 to be shaken drastically in order to mix them up under the sealing status, a resultant mixture is kept for 1 day at the temperature of 5° C. in order to separate it into water layer and oil layer, then a container of the mixture is opened to confirm the smell, the container is sealed again to be shaken to allow the mixture to be separated in a similar manner, followed by confirming the smell again, and thereafter such processes are repeated four times.

A similar confirmation task is done for the sake of comparison in such a manner that water instead of the extract is added to the same fish oil with the volume rate of fish oil:water=1:6.

Accordingly, the smell of the fish oil is determined by a smell test and the peroxide value is determined by a measured value.

Further, with regard to the functional food, the analysis is made under the conditions that the contained amounts of caffeoylquinic acid derivative and chlorigenic acid are observed by means of HPLC chart of the standard goods, respectively.

As a result thereof, the specimen material was the freeze dried ipomoea aquatica of the mixed species, and an analysis was done under the conditions that column is the inert sil ODS3(4.5×250 mm)5 μm, a mobile phase A is water:acetonitrile:acetic acid=90:10:0.1, a mobile phase B is water:acetonitrile:acetic acid=55:45:0.1, a first stage is A:B=isocrtic 100:0(10 min. hold), a second stage A:B=linear gradient 100:0 to 0:100 (40 min. hold), a third stage A:B=isocrtic 0:100 (10 min. hold), velocity of 1 ml/min., and UV detection at 320 nm.

Then, the ipomoea aquatica of the type showing the most drastic discoloration is described. Such ipomoea aquatica is required, upon harvesting, to be cut with a non-metal such as ceramic and thereafter the soil or crud on the cut surface is quickly washed away to macerate the cut surface into distilled water having low dissolved oxygen.

In order to avoid the contamination of rust of the iron or the copper, materials of the producing machine include stainless steel having passive state film, plastic or ceramic, if they are replaceable.

Upon blanching, if the water is of alkalinity, the object material or the leaves of the ipomoea aquatica will soften the water and is therefore unsuitable. Therefore, it is preferable to use the distilled water of the low dissolved oxygen.

The cooling water, the water to be supplied, the block freezing water, the glazing water that is in contact with the ipomoea aquatica for a long time after the blanching have to be selected considering the cost performance. It is preferable to select the water containing fewer impurities especially such as the strong acid, iron and copper and having low oxidation reduction potential and low dissolved oxygen showing around pH 9.0. In the processes after the cellular structures are destroyed through the blanching, it is effective to add ethanol to the aforementioned water to be used.

It is preferable for the processed food especially of the ipomoea aquatica that the water to be used immediately before or during the use is selected from the group consisting of the water showing pH equal to or more than 8.0, the degree of hardness equal to or less than 100 and the dissolved oxygen equal to or less than 5.0 mg/L, the water showing the oxidation reduction potential equal to or less than +200 mV, the hardness equal to or less than 100 and the dissolved oxygen equal to or less than 5.0 mg/L, the water showing dissolved oxygen equal to or less than 4.0 mg/L, the water showing the oxidation reduction potential equal to or less than 0 mV, or the water to which alcohol is added, in order to process the object material by performing any one of the cooling, the maceration, the block freezing while supplying water, and the glazing after blanching. In the case where the water showing the oxidation reduction potential equal to or less than 200 mV is used for cooling or macerating the object material, the water is required to be supplied continuously or at a constant frequency.

### EXAMPLE 2

Hereinafter, the production of the frozen ipomoea aquatica that has not been produced by frozen production due to the remarkable discoloration during the preservation thereof will be explained as an example.

Upon harvesting the raw material, after the material is cut by the non-metal such as ceramic, the soil or the crud on the cut surface is quickly washed away to macerate the cut surface into distilled water of the low dissolved oxygen, and then the material is to be transported to a factory noting the temperature regulation.

Hypochlorous acid is not used while transporting and washing the material at the factory, the material is required to be washed carefully with the neutral water having less impurities and dissolved oxygen, and the lower 2 cm of the stem is cut off again with a knife made of ceramic.

The blanching is to be done by supplying the electrolyte water containing less impurities and dissolved oxygen, of approximately neutral pH and with low oxidation reduction potential, and by using a rather large amount of water or by using a lesser amount of raw materials and setting at slightly higher temperature in order to perform sterilization at the same time.

When using the electrolyte water, what is important is that a water tank made of insulating material is used, such that the oxidation reduction potential of the water can be confirmed periodically.

After the above confirmation, the cooling process will be performed using a similar tank and supplying the electrolyte water of the low oxidation reduction potential showing the alkalinity and containing less impurities and dissolved oxygen.

Upon cooling the object material, the volume thereof is reduced and the cooling water is absorbed into the object cooled material, such that there is a necessity of avoiding the contamination of the iron ion and the pro-oxidant material. When natural water of the low oxidation reduction potential is used, it is necessary to check the component contained in the water upon selecting the water.

The freezing process will be performed subsequently. When performing the block freezing, a long period of contact of the supplied water with the object frozen material is expected, such that it is preferable that the water showing the alkalinity having a long span reduction property is used. It is suitable to use the distilled water excluding a foreshots together with weak acid and kalium, calcium, or compound of natrium such as baking soda, and to have the dissolved oxygen as low as possible will be more preferable.

With regard to the glazing water when performing the IQF freezing, similar points are to be noted.

Further, since the ipomoea aquatica shows the remarkable discoloration, it is effective to macerate the ipomoea aquatica into the high density ethanol after being heated through blanching or the like or to use such water for the sake of block water supply so that the above stated water is added with the ethanol.

After the freezing process, the ipomoea aquatica is packed in a container of the color or material for shielding light and of low oxygen permeability in order to avoid light, and the container is subjected to an air removal process or to a sealing process after being subjected to a nitrogen replacement to finally fill the container.

Throughout the processes, special care should be taken to the contamination of the metal oxide, especially, such as the iron and copper. Therefore, the devices in direct contact with the ipomoea aquatica or in indirect contact with the ipomoea aquatica through water should be made of stainless steel or nonmetal with the passive film.

Hereinafter, the extract of the ipomoea aquatica is exemplified for explanation. Upon harvesting the raw material, the material is to be cut using the nonmetal such as ceramic and then to have the soil or crud be washed away from the cut surface.

After the harvest, the material is to be quickly transported to the factory, without being washed with the hypochlorous acid, in order to be washed using the neutral water containing less impurities.

After the harvest, if the temperature regulation is suitably done, a remarkable discoloration will not appear before cells are destroyed; however, if the cells are destroyed through the heating process or the like, a rapid discoloration occurs. Therefore, care should be taken to the pH of the processing water, the contamination of metal or strong acid, specifically to the oxidation reduction potential and an electric conduction.

A practical procedure will be described in an example as set forth below. The preferred embodiment of the present invention will firstly be described hereinafter.

The washed material is placed in the tank made of the insulating material to be heated in the water having oxidation reduction equal to or less than 0 mV, the dissolved oxygen of 0 mg/L and pH between 9.0 and 11.0 in order to deactivate the enzyme and soften vegetable fiber as well.

Subsequently, the material is mashed together with the heated water quietly under the condition of no oxygen used in the device made of insulating material.

Further, while the water equal to or less than the oxidation reduction potential of 0 mV is added or continuously added thereto, the material is squeezed or filtered with the device made of insulating material. Thus obtained liquid is placed in a container made of insulating material to be frozen under the condition of no oxygen using low temperature nitrogen.

The resultant liquid is further subjected to a vacuum freeze dried process. After being dried, the liquid is placed in a bag of which the inner surface is made of a multi-layered insulating material such as a laminate of low oxygen permeability.

### EXAMPLE 3

A process of the example is generally the same as the preferred embodiment except for the following points. If a large amount of the natural water or the conditioned water meeting requirements according to regulation is used in each process, cost will increase. Therefore, in a normal production, the production is performed with less water to which care is take in order to reduce the contamination of oxygen or the impurities which facilitate the oxidization in such a manner that the ipomoea aquatica is heated with steam and mashed without water or the water to be used in each process is a lesser amount of water that is the distilled water or the obtainable boiled water having less impurities such as the metal and the strong acid.

Subsequently, the resulting object, juice or extracted liquid made in a manner such that the resulting object is added with a small amount of distilled water to be subjected to the squeezing process is placed in the container made of the insulating material, is added with alkali return flow of high reduction property, namely the alkali return flow roughly equal to or less than 0 mV of the oxidation reduction potential and roughly equal to or more than 9.0 pH, and subjected to the vacuum dried process and thereafter crushed under a no oxygen condition.

Since the oxidization of polyphenol reacts reversibly, the oxidization of polyphenol is done quickly in a short period of time in a circumstance with low oxidation reduction potential, but is done in a long span in a circumstance with high pH that is regulated with a compound of weak acid and kalium, calcium and natrium of a low standard single electrode potential. Therefore, it is observed that the extracted polyphenol keeps reduction property and shows the active oxygen removal ability again.

The thusly obtained dried object is placed in the bag of low oxygen permeability, the interior of the bag being multilayered made of the insulating material such as laminate to be sealed therein after the nitrogen substitution process, or the thusly obtained dried object is placed in the bag made of the insulating material to be subjected to an air-nitrogen substitution process and then is placed in a can to be sealed after performing the nitrogen substitution process with regard to the air present between the can and the bag in order to preserve the object.

Thereafter, the object is produced in the forms of tablets, capsule filling material and pills coated with sugar for the purpose of taking them in the same way as SODs and vitamins.

Since it is observed that the iron and polyphenol contributes to the discoloration of the ipomoea aquatica, it is preferable for the ipomoea aquatica to be processed under such circumstances that the oxidization of the components can be suppressed.

Accordingly, the processing is performed using the water containing less pro-oxidant material such as the iron, dissolved oxygen and acid or the water with low oxidation reduction potential.

Specifically, it is required to avoid the contamination of the metal ion and the iron rust during the processing step as much as possible.

In addition thereto, in any of the processes, more preferably, in a plurality of processes, among the blanching, the cooking, the cooling after the blanching, the maceration, the seasoning, the water supply, or the block freezing while supplying water and the glazing, the water containing the oxalic acid or the manganese oxalate is used.

In the case that the oxalic acid is added as the food additive, it is necessary, in Japan for the sake of production and sale, to remove the oxalic acid completely before producing the final product, such that the removing process is required to be added into the above mentioned processes.

On the other hand, in the case where food containing the manganese oxalate as a submaterial is processed together with the dried object, a removal process for the manganese oxalate is not required, such that it is preferable to use the suitable submaterial in each process.

In the case where the production and the sale will be performed in the countries other than Japan, it is necessary to use the oxalic acid and the manganese oxalate or the submaterial containing those in a manner in accordance with the rules of those countries.

### EXAMPLE 4

An example of the production of the ipomoea aquatica is described hereinafter.

A small amount of dried powder of arum root is added to the water to the extent that one does not feel a bitter taste and the solution is then mixed well.

Here, if the amount of the dried powder of arum root is too much, the solution will be bitter and have strong viscosity, such that it is unsuitable for use as the processing water.

With the water, the blanching process is performed.

Such water is to be used for cooling after the blanching that a small amount of the dried powder of arum root is added and mixed together well while heating and thereafter the mixed water is cooled by stirring.

Then, the block freezing process will be performed while supplying water. Here, the water to be supplied is made so that the water used as the cooling water is further diluted or is the neutral water containing less impurities.

Alternatively, if spinach is processed at the same factory, the water can be substituted with the water after blanching the spinach, namely the so-called spinach extracted hot water extract, instead of the solution of dried powder of arum root.

Finally, the final product is frozen and packed for the sake of frozen storage.

### INDUSTRIAL APPLICABILITY

With regard to the industrial applicability of the present invention, what is specifically emphasized is: where the ipomoea aquatica has an excellent regeneration ability and growing speed and produced in large amounts, and further is the promised excellent food material which can be produced in vast amounts in a short period of time and which has high nutrition, since the distribution area is limited due to its bad keeping, a suitable distribution method and processing method have not been found, resulting in being limited to the use of fresh vegetable or food for animals and thus being impossible to be used in a satisfactory way, the present invention enables expansion of the use of the ipomoea aquatica into distant areas, namely, all over the world.

Further, it is extremely significant that a new effective usage method for the ipomoea aquatica is proposed according to the present invention besides the use for food under such circumstances that, since it has been difficult to distribute the ipomoea aquatica to the distant area due to the weakness of resistance property in distribution, the ipomoea aquatica has not been known to the public except for the production region and food industry although being referred to of its effect to remedy diseases such as diabetes, no sufficient study has been done as to the effective use of such excellent function which the ipomoea aquatica has such as not only for the polyphenol but also viscosity material which is considered as polysaccharide.

As a matter of course, frozen food companies or the like has been playing a central role in doing such a test for preventing the discoloration while processing the ipomoea aquatica recognizing its excellent crispness and the likelihood is that the companies are still interested in this ipomoea aquaica. In view of the present status that the frozen green vegetables are under lacking and needy circumstances because of the problem of residual agricultural chemicals in China and the problem has not been resolved and thus those frozen green vegetables are still not commercialized, there already is demand for those frozen green vegetables and the problem has been resolved by the present invention, it is destined that those frozen green vegetables will be utilized and commercialized at an early date.

At the same time, it is significant that this problem was considered in an aspect other than an aspect of the soil components upon cultivation which has been considered to be a main factor of this problem, the classification of the ipomoea aquatica forsk that has already been recognized was further segregated according to shapes of leaves. Further, it is significant that such a tendency was found that, according to the segregated system without being misled by the mixed community of the mixed species and hybrid, the discoloration after being heated or frozen differs and such discoloration differs portion by portion, and further such a treatment method of green vegetables was found that the effect can be produced commonly between green vegetables although a difference occurs according to the system.

It will be extremely effective to recognize genetic differences between systems as proposed in the present invention. With the proposed system, a test result showing a constant tendency, which has not been obtained in conventional studies, will be obtainable, and a preferable result will be expected in confirming the affect by the soil component and circumstances to colors and cultivation method, study of the system containing a lot of effective components, and effective confirmation of the extracted material system. More specifically, in photos and drawings concerning studies of the ipomoea aquatica in connection with the circumstances investigated at the time when the present invention was made, mixed species or mixed community of the ipomoea aquatica was not classified but are treated as the same species of specimens when reporting the study result.

Accordingly, it is an extremely significant contribution of the present invention that the ipomoea aquatica will be supplied in large amounts and at low cost as stated above, will be capable of being increased of the production amount rapidly, will be satisfactorily used as the resource which has eating habit, is distributed as food and can be collected with assuming the safety thereof.

Possibilities of the industrial applicability of each of the productions according to the present invention are described hereinafter. The fresh ipomoea aquatica which recently came to be sold in summer season in Japan drastically loses its freshness while being distributed due to the progress of degrading, and thus the fresh ipomoea aquatica becomes worse in a short period of time while displayed at the store of the mass merchandiser, resulting in being still often placed at the store even where it becomes in a bad condition. Therefore, the distribution in which this problem is resolved is effective to retailers and domestic planters and can be practiced immediately.

With regard to the frozen processed food, needless to say, food companies are equally interested in the development of this food material, especially under such present circumstances where, facing to the problem of residual cultivation chemicals in China, there is a shortage of frozen green vegetables. Therefore, the present food material which has the excellent nutrition value and which is capable of being supplied at low cost, and which further can reduce agricultural chemicals such as insect repellant thanks to the originally contained polyphenol that insects hate is spread by the wind and has good prospects for the future. Since an early and a large amount of demand exists for the ipomoea aquatica, as soon as the cultivation management structural plan is established in a producing area, it is destined that the production will be in operation soon.

Now, possibilities of industrial use applicability as to the purification of the fish oil as food additives or processing agent will be described below. The extract of the ipomoea aquatica daily obtainable with ease at low cost in large amounts under the condition of keeping the strong antioxidation in south-east Asia area where the fish oil damaged by the heating process is produced in large amounts as the residual product because of the production by large amounts of the canned tuna for exporting to Japan, Europe and United States is extremely effective and no additional facilities are required since the present invention is made such that the processes of purification of fish oil can be used with the actual production process. Thus, the present invention is very practicable.

There are lot of such companies all over the world that produce high unsaturated fatty acid such as DHA, EPA and arachidonic acid from the fish oil for the use of functional food which is so-called health food. Each company criticizes the quality thereof on the basis of the removal of the smell due to oxidization and a residual degree of fish smell. As for the main method of reducing the fish smell, a collection of fish oil of a good quality, a temperature at the distilling process and a distilling method, and addition of the antioxidation agent such as vitamin is effective.

Presently, it is observed that the extract of the ipomoea aquatica has an effect of removing the smell of unsaturated fatty acid and in suppressing the acid. Therefore, a practical use at an early time will be achieved in view of the background that the ipomoea aquatica is obtainable at low cost and in large amounts with ease, there is less lowering of an extraction rate since the separation of fish oil from the solution, if it is water soluble, is easy, an addition of a process to the water to be used for washing fish at the initial step of processing the fish oil will enhance the smell removing effect and oxides removing effect better than the conventional washing, and there is eating habit of the additives and auxilially agent to be regarded as important in producing the functional food when considering the presence or the absence of the eating habit.

It is also effective to use the soluble extract after being purified in the smell removal process while performing the enhanced unsaturated fatty acid purification process, or to suppress the oxidization by purifying fat-soluble polyphenol contained in the ipomoea aquatica to directly add to the unsaturated fatty acid the antioxidation agent or to perform the removal of the active oxygen.

Finally, usefulness of the ipomoea aquatica to be used in the functional food and as the material from which specific substance is extracted is described hereinafter. Currently, there is a health-conscious tendency, the food containing the specific polyphenol such as chloroginic acid which is excellent in antioxidation, draws attention because of having the active oxygen removal ability, is under a good safety and is capable of being supplied constantly and at low cost and the caffeoylquinic acid having antimutagenicity is an expected commercial material to which an early demand will be made since it has a high additional value and meets the current of the times while keeping the cost thereof low.

An amount of the tricaffeoylquinic acid contained in the ipomoea aquatica confirmed at present is small since the specimen from which the tricaffeoylquinic acid was extracted was the mixture of several kinds of ipomoea aquatica. If the kinds of the ipomoea aquatica are segregated to specify the ipomoea aquatica containing a large amount of tricaffeoylquinic acid and if the suitable extraction method is selected, it will become possible to have the ipomoea aquatica include more tricaffeoylquinic acid and to extract it effectively. Thus, it is extremely effective.

In addition to the above, the ipomoea aquatica having the excellent regeneration ability and extremely high growing speed is, as already stated above, available in large amounts in Africa and south-east Asia where there are a large number of AIDS cases. With such features, it is possible for the ipomoea aquatica to be rapidly increasingly produced as food and extraction material and further is actually prone to be increasingly produced for the sake of the environmental protection such as water purification. That is, the ipomoea aquatica will be destined to be an effective extraction material because the supply can be rapidly increased.

With regard to the functional food and the materials for extracting the specific substance having problems supplying such as the stable supply and the stable cost, more specifically, the problems being the scarcity of the material, an unstable supply due to seasonality, a necessary time for collecting the material, the contamination of the impurities, an obtention route, such that there are a lot of products that have problems derived from the lack of products, improper price, and bad quality and the like because the products can not meet the rapid change in demand. On the other hand, the ipomoea aquatica used as the raw material in the present invention does not have such kinds of problems, which is a large advantageous result for the users.

As stated above, the present invention is expected to play an important role in the future food demand and supply and the health enhancement. The present invention largely contributes to such circumstances and has a large possibility.

As stated above, only considering the ipomoea aquatica, the demand is already present as apparent from the facts that food companies have been repeating tests as to the excellent property of the material and the problems have not been resolved to date, such that the early use thereof is expected.

It may be redundant; however, the reasons will be stated hereinafter.

The ipomoea aquatica, in view of the production and supply thereof, grows fast in warm areas and regenerates from the same roots if the root remains upon harvest.

The ipomoea aquatica has a strong vital energy and can be subjected to the water cultivation, i.e., the ipomoea aquatica is extremely easy to cultivate and thus can be produced in large amounts.

As to the product characteristics, the ipomoea aquatica has the unique firmness and the crispness, and has a wide applicability because of the acceptable taste thereof. Further, since the ipomoea aquatica that will not discolor has been developed according to the present invention, the ipomoea aquatica is an effective food material of the green color.

The ipomoea aquatica contains the large amount of polyphenol, has the excellent antioxidation effect, contains the large amount of iron and calcium and has the rich nutrition value. Therefore, the ipomoea aquatica is the effective food material to the extent that the effect takeoff eating the ipomoea aquatica is publicly known in China and Taiwan.

In the recent trend where people are coming to be interested in health, it is effective to provide the ipomoea aquatica that contains the large amount of polyphenol, that is noted as having the antioxidation effect, that is commercialized without losing the antioxidation effect and that is the high polyphenol containing food which can be preserved.

Further, the largest advantage of the ipomoea aquatica is the low price of the raw material owing to the easy production thereof.

Since the ipomoea aquatica can be produced more easily than the frozen spinach or the frozen peruviridis and can be produced throughout the year in south Asia in the high temperature area, a sufficient competitive power in price can be kept even if the processing water regulation involves cost, and the ipomoea aquatica has the excellent characteristic, so that a rapid demand expansion is expected.

Further, the ipomoea aquatica is effective for purification of water and thus draws attention in Japan to be expected for further expansion in production thereof. Under the circumstances, it is extremely important to expand the applicability by enabling the frozen storage and the preservation at the normal temperature through the processing, and further to expand the demand thereof.

In addition to the above, use or demand of the vegetables such as leaves of a perilla and garland chrysanthemum that are prone to discolor as the processed materials can be expected.

Furthermore, the present invention is effective to enhance the quality of the frozen spinach and the peruviridis that are currently under distribution in large amounts. Under the circumstances that people are interested in the polyphenol such as contained in wine or cocoa, the present invention is quite effective and draws high attention.

The characteristic of the processed product, under the circumstances that people are more interested in health, is the large containing amount of polyphenol, which is especially noted for its antioxidation effect. The present invention that achieves the processing of the polyphonel without losing the antioxidation ability and realizes the preservation thereof is of interest to people and is effective.

The characteristic of the processed product is the unique crispness and the acceptable taste which broaden the application. Since the ipomoea aquatica was developed according to the present invention to produce the a type that does not discolor, the ipomoea aquatica will become the effective food material of green color that is easy to use.

Further, since the ipomoea aquatica came to be noted also in Japan since it is effective for the purification of water, more expansion of production is forseen. Therefore, the present invention that enabled the expansion of the application of the ipomoea aquatica as the raw material for processed food to be preserved in frozen or normal condition is quite important.

1. A cultivation method of ipomoea aquatica, wherein the ipomoea aquatica roughly classified according to a color of flower and a width of leaf is further classified into types according to a difference of an entire shape of a leaf, a shape of leaf within 5.0 cm radius from a leaf base, and differences of shapes of leaves between each other on the same stem and thusly classified ipomoea aquatica is selectively cultivated.

2. The cultivation method of ipomoea aquatica as claimed in claim 1, wherein the object ipomoea aquatica to be classified is classified in such a manner that a kind of ipomoea aquatica of a narrow leaf such as a bamboo leaf or a green stem is further classified into type according to the shape of the leaf within a 3.0 cm radius from the leaf stem and an entire shape of the leaf.

3. The cultivation method of ipomoea aquatica as claimed in claim 1, wherein the classification excludes such kind of ipomoea aquatica including a plurality of leaves with a projection in the vicinity of the leaf base.

4. The cultivation method of ipomoea aquatica as claimed in claim 1, wherein the classification selects a kind of ipomoea aquatica having such leaves on one stem that a curved line of the end portion of the leaf from the leaf base and a leaf top continues from the leaf base toward the leaf top without creating the projected portion to cultivate such ipomoea aquatica.

5. A cultivation method of ipomoea aquatica, wherein the ipomoea aquatica is identified by its entirety including its roots in order to pick it up, a discoloration of the ipomoea aquatica after being heated is observed, and the roots that showed lesser discoloration are selected to cultivate.

6. The cultivation method of ipomoea aquatica as claimed in claim 5, wherein the task of selecting the roots is performed more than two times or periodically in a repeating manner.

7. The cultivation method of ipomoea aquatica as claimed in claim 5, wherein the selecting task of the roots is performed using a kind of ipomoea aquatice having such leaves on one stem that a curved line of the end portion of the leaf from the leaf base and a leaf top continues from the leaf base toward the leaf top without creating the projected portion.

8. An ipomoea aquatica, wherein the ipomoea aquatica is cultivated according to the method as claimed in claim 1.

9. An ipomoea aquatica, wherein such leaves are on one stem that a curved line of the end portion of the leaf from the leaf base and a leaf top continues from the leaf base toward the leaf top without creating the projected portion.

10. An ipomoea aquatica, wherein no discoloration into brown or black occurs after being heated or frozen.

11. The ipomoea aquatica as claimed in claim 10, further comprising such a leaf that a curved line of the end portion of the leaf from the leaf base and a leaf top continues from the leaf base toward the leaf top without creating the projected portion.

12. A processed food of the ipomoea aquatica, wherein the ipomoea aquatica as claimed in claim 9 is used as the raw material.

13. A processed food of the ipomoea aquatica, wherein a bud, a stem, a leaf stem and a leaf of the ipomoea aquatica from which the bud, the stem and the leaf stem which discolor after being heated are excluded are used as a raw material.

14. A vegetable preserving method, wherein an unprocessed vegetable of which leaf portion or stem portion are edible is supplied with water in such a manner at least one of a cut surface of the stem potion or a cut surface of the leaf stem is macerated, and the vegetable is distributed and preserved in this status.

15. The vegetable preserving method as claimed in claim 14, wherein the vegetable is subjected to a light shielding and kept at a temperature between equal to or more than 0° C. and equal to or less than 5° C. under a status at least one of the cut surfaces of the stem portion or the cut surfaces of the leaf stem is macerated.

16. A vegetable preserving method, wherein an object processed material after the blanching is macerated into cooling water or glazing water to which alcohol is added in order to cool or freeze the vegetable.

17. The vegetable preserving method as claimed in claim 16, wherein the cooling water or the glazing water is a solution to which alcohol is added and which is at a temperature equal to or less than 30° C.

18. The vegetable preserving method as claimed in claim 16, wherein the alcohol is an ethanol.

19. The vegetable preserving method as claimed in claim 16, wherein any one of oxalic acid, oxalic acid contents, amino acid, organic salt, phosphate and powder of arum root or food additive of a same kind of the powder of arum root are added to the cooling water or the glazing water together with the alcohol.

20. An ipomoea aquatica preserving method, wherein the ipomoea aquatica roughly classified according to a color of flower and a width of leaf is further classified into type according to a difference of an entire shape of a leaf, a shape of leaf within 5.0 cm radius from a leaf base, and differences of shapes of leaves each other on the same stem to select such ipomoea aquatica, and thus selected ipomoea aquatica after a blanching is macerated into cooling water or glazing water to which alcohol is added in order to cool or freeze the ipomoea aquatica.

21. The ipomoea aquatica preserving method as claimed in claim 20, wherein the selection is performed to mainly select the ipomoea aquatica having such a leaf that a curved line of the end portion of the leaf from the leaf base and a leaf top continues from the leaf base toward the leaf top without creating the projected portion.

22. An ipomoea aquatica, wherein the ipomoea aquatica is preserved using the preserving method as claimed in claim 20.

23. A fish oil processed food, wherein the fish oil processed food is subjected to any one of a washing process, a smell removing process, an oxide removing process or an antioxidation suppressing process by using the ipomoea aquatica or an extract of the ipomoea aquatica.

24. A processed food, wherein the processed food contains caffeoylquinic acid, chlorogenic acid, dicaffeoylquinic adic, tricaffeoylquinic acid extracted from the ipomoea aquatica or derivatives thereof or extracts thereof.

25. A processed food, wherein any one of a cooling process, a maceration process, a block freezing process while supplying water, a glazing process is performed with respect to an object processed material after blanching using water selected form the water showing pH equal to or more than 8.0, a degree of hardness equal to or less than 100 and a dissolved oxygen equal to or less than 5.0 mg/L, the water showing the oxidation reduction potential of equal to or less than +200 mV, the hardness equal to or less than 100 and the dissolved oxygen equal to or less than 5.0 mg/L, the water showing the dissolved oxygen equal to or less than 4.0 mg/L, the water showing the oxidation reduction potential equal to or less than 0 mV, or the water to which alcohol is added, at a time immediately before or during the use of such water, in order to process the food.

26. The processed food as claimed in claim 25, wherein the object material to be processed is an ipomoea aquatica.

27. An extract of ipomoea aquatica, wherein the extract is extracted from the ipomoea aquatica using polar solvent and has an active oxygen eliminating ability.

28. The extract of ipomoea aquatica as claimed in claim 27, wherein the extract of the ipomoea aquatica is water containing water, oxalic acid or oxalate, and further containing polyphenol and vitamin extracted from the ipomoea aquatica.

29. A processed food, wherein any one of a cooling process, a maceration process, a block freezing process while supplying water, a glazing process is performed after blanching using water containing oxalic acid or oxalate in order to process the food.

30. An ipomoea aquatica, wherein the ipomoea aquatica is cultivated according to the method as claimed in claim 5.

31. A processed food of the ipomoea aquatica, wherein the ipomoea aquatica as claimed in claim 10 is used as the raw material.
